(19) United States
(12) Patent Application Publication
(10) Pub. No.: US 2024/0205837 A1
(43) Pub. Date: Jun. 20, 2024

(54) VARIABLE UPLINK GRANT CONFIGURATIONS FOR HIGH POWER CLASS DEVICES

(71) Applicant: QUALCOMM Incorporated, San Diego, CA (US)

(72) Inventors: Akash Kumar, Hyderabad (IN); Sumitkumar Shrikant Dubey, Hyderabad (IN)

(21) Appl. No.: 18/069,140

(22) Filed: Dec. 20, 2022

(51) Int. Cl. H04W 52/14; H04W 72/1268; H04W 72/563

(52) U.S. Cl. CPC H04W 52/146; H04W 72/1268; H04W 72/563

(57) ABSTRACT

Methods, systems, and devices for wireless communications, including variable uplink grant configurations for high power class devices are described. A user equipment (UE) may transmit an advertisement message indicating an uplink transmission duty cycle associated with a first power class (PC) mode, the first PC mode of the UE corresponding to a higher transmission power level than a second PC mode. The UE may receive a set of uplink grants associated with a quantity of transmission resources exceeding the advertised uplink transmission duty cycle. The UE may transmit using the first PC mode, a subset of uplink messages associated with a subset of the set of uplink grants to satisfy the uplink transmission duty. Additionally or alternatively, the UE may transmit using the first PC mode, a first subset of uplink messages on a first transmission chain and a second subset of uplink messages on a second transmission chain.

### FIELD OF TECHNOLOGY

The following relates to wireless communications, including variable uplink grant configurations for high power class devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support variable uplink grant configurations for high power class devices. For example, the described techniques provide for a user equipment (UE) that may decrease instances of power class (PC) fallback. For example, the UE may check uplink scheduling from a network entity and identify if the scheduled uplink exceeds an advertised uplink duty cycle of the UE for operation in a higher PC (e.g., PC2 or PC1.5). The UE may further check if the UE is operating in a far cell condition or if transmission power levels below a configured threshold. In addition, the UE may check if the amount of uplink block error rate (BLER) associated with lower PC operations (e.g., PC3) exceeds a configurable threshold. If the UE is in far call conditions or if the BLER exceeds the configured threshold, the UE may maintain uplink transmissions at PC2 or PC1.5. As such, if the difference between the scheduled uplink duty cycle and advertised duty cycle is below a configurable threshold, the UE may refrain from transmitting (e.g., prune) one or more uplink messages scheduled by one or more of the uplink grants such that the scheduled uplink duty cycle may be less than or equal to the advertised uplink duty cycle. In some examples, the UE may operate in accordance with uplink carrier aggregation (CA). In such examples, the UE may prune uplink grants such that a cumulative duty cycle across the carriers may be less than or equal to the advertised duty cycle.

Additionally, or alternatively, the UE may be configured for multi-chain transmissions, where each chain may have a respective advertised duty cycle. As such, if the number of uplink grants is above the configured advertised duty cycle, the UE may transmit a first set of uplink messages associated with a first subset of the uplink grants on a first transmission chain and transmit a second set of uplink messages associated with a second subset of the uplink grants on a second transmission chain. Perfuming a chain switching operation may satisfy the advertised duty cycle of each chain while operating in accordance with PC2 or PC1.5.

A method for wireless communications at a user equipment (UE) is described. The method may include transmitting, to a network entity, an advertisement message indicating an uplink transmission duty cycle associated with a first power class mode of the UE, the first power class mode of the UE corresponding to a higher transmission power level than a second power class mode of the UE, receiving, from the network entity, a set of multiple uplink grants associated with a time interval, a quantity of transmission resources scheduled by the set of multiple uplink grants during the time interval exceeding the uplink transmission duty cycle associated with the first power class mode, and transmitting, using the first power class mode, a first subset of uplink messages associated with a first subset of the set of multiple uplink grants to satisfy the uplink transmission duty cycle for the time interval based on dropping transmission of a second subset of uplink messages associated with a second subset of the set of multiple uplink grants.

An apparatus for wireless communications at a UE is described. The apparatus may include a processor, memory coupled with the processor, and instructions stored in the memory. The instructions may be executable by the processor to cause the apparatus to transmit, to a network entity, an advertisement message indicating an uplink transmission duty cycle associated with a first power class mode of the UE, the first power class mode of the UE corresponding to a higher transmission power level than a second power class mode of the UE, receive, from the network entity, a set of multiple uplink grants associated with a time interval, a quantity of transmission resources scheduled by the set of multiple uplink grants during the time interval exceeding the uplink transmission duty cycle associated with the first power class mode, and transmit, using the first power class mode, a first subset of uplink messages associated with a first subset of the set of multiple uplink grants to satisfy the uplink transmission duty cycle for the time interval based on dropping transmission of a second subset of uplink messages associated with a second subset of the set of multiple uplink grants.

Another apparatus for wireless communications at a UE is described. The apparatus may include means for transmitting, to a network entity, an advertisement message indicating an uplink transmission duty cycle associated with a first power class mode of the UE, the first power class mode of the UE corresponding to a higher transmission power level than a second power class mode of the UE, means for receiving, from the network entity, a set of multiple uplink grants associated with a time interval, a quantity of transmission resources scheduled by the set of multiple uplink grants during the time interval exceeding the uplink transmission duty cycle associated with the first power class mode, and means for transmitting, using the first power class mode, a first subset of uplink messages associated with a first subset of the set of multiple uplink grants to satisfy the uplink transmission duty cycle for the time interval based on dropping transmission of a second subset of uplink messages associated with a second subset of the set of multiple uplink grants.

A non-transitory computer-readable medium storing code for wireless communications at a UE is described. The code may include instructions executable by a processor to transmit, to a network entity, an advertisement message indicating an uplink transmission duty cycle associated with a first power class mode of the UE, the first power class mode of the UE corresponding to a higher transmission power level than a second power class mode of the UE, receive, from the network entity, a set of multiple uplink grants associated with a time interval, a quantity of transmission resources scheduled by the set of multiple uplink grants during the time interval exceeding the uplink transmission duty cycle associated with the first power class mode, and transmit, using the first power class mode, a first subset of uplink messages associated with a first subset of the set of multiple uplink grants to satisfy the uplink transmission duty cycle for the time interval based on dropping transmission of a second subset of uplink messages associated with a second subset of the set of multiple uplink grants.

Some examples of the method, apparatuses, and non-transitory computer-readable medium described herein may further include operations, features, means, or instructions for transmitting, using the second power class mode, a set of multiple uplink signals based on a second quantity of transmission resources scheduled during a second time interval exceeding the uplink transmission duty cycle associated with the first power class mode.

In some examples of the method, apparatuses, and non-transitory computer-readable medium described herein, transmitting the first subset of the uplink messages may include operations, features, means, or instructions for transmitting the first subset of the uplink messages using the first power class mode based on a BLER associated the second power class mode satisfying a threshold.

Some examples of the method, apparatuses, and non-transitory computer-readable medium described herein may further include operations, features, means, or instructions for receiving a first uplink grant and a second uplink grant of the set of multiple uplink grants, each of the first uplink grant and the second uplink grant being associated with a different carrier, where the first subset of the uplink messages includes a first uplink message scheduled by the first uplink grant in accordance with a prioritization scheme indicating to prioritize the first uplink grant indicating a first resource allocation that may be larger than a second resource allocation of the second uplink grant.

Some examples of the method, apparatuses, and non-transitory computer-readable medium described herein may further include operations, features, means, or instructions for receiving a first uplink grant of the set of multiple uplink grants that indicates a first resource allocation on a primary component carrier and a second uplink grant of the set of multiple uplink grants that indicates a second resource allocation on a secondary component carrier, where the first subset of the uplink messages includes a first uplink message scheduled by the first uplink grant on the primary component carrier in accordance with a prioritization scheme indicating to prioritize transmission via the primary component carrier.

Some examples of the method, apparatuses, and non-transitory computer-readable medium described herein may further include operations, features, means, or instructions for receiving a first uplink grant of the set of multiple uplink grants that indicates a first resource allocation on a first carrier for transmission of control information and first data and a second uplink grant of the set of multiple uplink grants that indicates a second resource allocation on a second carrier for transmission of second data, where the first subset of the uplink messages includes the control information and the first data scheduled by the first uplink grant in accordance with a prioritization scheme indicating to prioritize multiplexing data with control information.

Some examples of the method, apparatuses, and non-transitory computer-readable medium described herein may further include operations, features, means, or instructions for transmitting, using the first power class mode, the first subset of the uplink messages associated with the first subset of the set of multiple uplink grants based on the first subset of the uplink messages being associated with single transmission chain transmission.

Some examples of the method, apparatuses, and non-transitory computer-readable medium described herein may further include operations, features, means, or instructions for selecting the first subset and the second subset of the set of multiple uplink grants based on a prioritization scheme for prioritization of transmission of uplink messages associated with the set of multiple uplink grants.

A method for wireless communication at a UE is described. The method may include transmitting, to a network entity, an advertisement message indicating an uplink transmission duty cycle associated with a first power class mode of the UE, the first power class mode of the UE corresponding to a higher transmission power level than a second power class mode of the UE, receiving, from the network entity, a set of multiple uplink grants associated with a time interval, a quantity of transmission resources scheduled by the set of multiple uplink grants during the time interval exceeding the uplink transmission duty cycle associated with the first power class mode, transmitting, using the first power class mode on a first transmission chain of the UE, a first subset of uplink messages associated with a first subset of the set of multiple uplink grants to satisfy the uplink transmission duty cycle for the first transmission chain during the time interval, and transmitting, using the first power class mode on a second transmission chain of the UE, a second subset of the uplink messages associated with a second subset of the set of multiple uplink grants to satisfy the uplink transmission duty cycle for the second transmission chain during the time interval.

An apparatus for wireless communication at a UE is described. The apparatus may include a processor, memory coupled with the processor, and instructions stored in the memory. The instructions may be executable by the processor to cause the apparatus to transmit, to a network entity, an advertisement message indicating an uplink transmission duty cycle associated with a first power class mode of the UE, the first power class mode of the UE corresponding to a higher transmission power level than a second power class mode of the UE, receive, from the network entity, a set of multiple uplink grants associated with a time interval, a quantity of transmission resources scheduled by the set of multiple uplink grants during the time interval exceeding the uplink transmission duty cycle associated with the first power class mode, transmit, using the first power class mode on a first transmission chain of the UE, a first subset of uplink messages associated with a first subset of the set of multiple uplink grants to satisfy the uplink transmission duty cycle for the first transmission chain during the time interval, and transmit, using the first power class mode on a second transmission chain of the UE, a second subset of the uplink messages associated with a second subset of the set of multiple uplink grants to satisfy the uplink transmission duty cycle for the second transmission chain during the time interval.

Another apparatus for wireless communication at a UE is described. The apparatus may include means for transmitting, to a network entity, an advertisement message indicating an uplink transmission duty cycle associated with a first power class mode of the UE, the first power class mode of the UE corresponding to a higher transmission power level than a second power class mode of the UE, means for receiving, from the network entity, a set of multiple uplink grants associated with a time interval, a quantity of transmission resources scheduled by the set of multiple uplink grants during the time interval exceeding the uplink transmission duty cycle associated with the first power class mode, means for transmitting, using the first power class mode on a first transmission chain of the UE, a first subset of uplink messages associated with a first subset of the set of multiple uplink grants to satisfy the uplink transmission duty cycle for the first transmission chain during the time interval, and means for transmitting, using the first power class mode on a second transmission chain of the UE, a second subset of the uplink messages associated with a second subset of the set of multiple uplink grants to satisfy the uplink transmission duty cycle for the second transmission chain during the time interval.

A non-transitory computer-readable medium storing code for wireless communication at a UE is described. The code may include instructions executable by a processor to transmit, to a network entity, an advertisement message indicating an uplink transmission duty cycle associated with a first power class mode of the UE, the first power class mode of the UE corresponding to a higher transmission power level than a second power class mode of the UE, receive, from the network entity, a set of multiple uplink grants associated with a time interval, a quantity of transmission resources scheduled by the set of multiple uplink grants during the time interval exceeding the uplink transmission duty cycle associated with the first power class mode, transmit, using the first power class mode on a first transmission chain of the UE, a first subset of uplink messages associated with a first subset of the set of multiple uplink grants to satisfy the uplink transmission duty cycle for the first transmission chain during the time interval, and transmit, using the first power class mode on a second transmission chain of the UE, a second subset of the uplink messages associated with a second subset of the set of multiple uplink grants to satisfy the uplink transmission duty cycle for the second transmission chain during the time interval.

Some examples of the method, apparatuses, and non-transitory computer-readable medium described herein may further include operations, features, means, or instructions for transmitting the first subset of the uplink messages on the first transmission chain and the second subset of the uplink messages on the second transmission chain based on the set of multiple uplink grants being associated with single-input single-output (SISO) transmission.

Some examples of the method, apparatuses, and non-transitory computer-readable medium described herein may further include operations, features, means, or instructions for transmitting, during a first portion of the time interval, a first set of sounding reference signals via the second transmission chain and the first subset of the uplink messages via the first transmission chain and transmitting, during a second portion of the time interval, a second set of sounding reference signals via the first transmission chain and the second subset of the uplink messages via the second transmission chain.

Some examples of the method, apparatuses, and non-transitory computer-readable medium described herein may further include operations, features, means, or instructions for transmitting, using the first power class mode on the second transmission chain of the UE, the second subset of the uplink messages during a second portion of the time interval based on the first subset of uplink grants satisfying the uplink transmission duty cycle during a first portion of the time interval.

### BRIEF DESCRIPTION OF THE DRAWINGS

FIG. 1 illustrates an example of a wireless communications system that supports variable uplink grant configurations for high power class devices in accordance with one or more aspects of the present disclosure.

FIG. 2 illustrates an example of a wireless communications system that supports variable uplink grant configurations for high power class devices in accordance with one or more aspects of the present disclosure.

FIG. 3 illustrates an example of a process flow that supports variable uplink grant configurations for high power class devices in accordance with one or more aspects of the present disclosure.

FIG. 4 illustrates an example of a process flow that supports variable uplink grant configurations for high power class devices in accordance with one or more aspects of the present disclosure.

FIGS. 5 and 6 show block diagrams of devices that support variable uplink grant configurations for high power class devices in accordance with one or more aspects of the present disclosure.

FIG. 7 shows a block diagram of a communications manager that supports variable uplink grant configurations for high power class devices in accordance with one or more aspects of the present disclosure.

FIG. 8 shows a diagram of a system including a device that supports variable uplink grant configurations for high power class devices in accordance with one or more aspects of the present disclosure.

FIGS. 9 through 12 show flowcharts illustrating methods that support variable uplink grant configurations for high power class devices in accordance with one or more aspects of the present disclosure.

### DETAILED DESCRIPTION

In some examples of wireless communications, one or more network devices may operate in accordance with fifth generation (5G) New Radio (NR) communications. In some cases, a user equipment (UE) may experience challenges in 5G NR due to higher bandwidth operation using a greater transmission power output to maintain a threshold power spectral density (PSD) at the network side. For example, the UE may operate in accordance with PC2 (e.g., 26 dbm transmission power level) or PC1.5 (e.g., 29 dbm transmission power level) which may provide a higher transmission power level for the UE compared to PC3 (e.g., 23 dbm transmission power level). In some cases, however, higher transmit powers impose challenges at the UE. For example, thermal effects caused by continuous operation at higher power levels may decrease the efficiency and quality of wireless communications. Additionally, or alternatively, power operation associated with PC2 and PC1.5 may result in gain drop at a power amplifier of the UE in cases of back-to-back uplink scheduling. To mitigate the effects of high power level uplink transmissions, the UE may advertise an uplink duty cycle supported by the UE for a given radio frequency band or a set of radio frequency bands for PC2 and PC1.5. In some examples, the advertise uplink duty cycle may indicate a threshold percentage of symbols during a time period that the UE may be scheduled for uplink transmission for a particular PC to operate in accordance with an electromagnetic energy assumption criterion. If a scheduled uplink duty cycle from the network exceeds the advertised duty cycle limit, the UE may fall back to PC3. However, for far cell UEs in higher frequency bands operating at a higher bandwidth, a fallback to PC3 may increase uplink block error rate (BLER) and result in uplink channel cyclic redundancy check (CRC) failures. The increase in BLER and CRC failures may result in radio link failure (RLF) impacting the user experience.

As such, the UE may decrease instances of PC3 fallback by operating in accordance with the techniques described herein. For example, the UE may check the uplink scheduling and identify if the scheduled uplink exceeds the advertised duty cycle. The UE may further check if the UE is operating in a far cell condition or if transmission power levels below a configured threshold. In addition, the UE may check if the amount of uplink BLER associated with PC3 operations exceeds a configurable threshold. If the UE is in far call conditions or if the BLER exceeds the configured threshold, the UE may maintain uplink transmissions at PC2 or PC1.5. As such, if the difference between the scheduled uplink duty cycle and advertised duty cycle is below a configurable threshold, the UE may refrain from transmitting (e.g., prune) one or more uplink messages scheduled by one or more of the uplink grants such that the scheduled uplink duty cycle may be less than or equal to the advertised uplink duty cycle.

In some examples, the UE may operate in accordance with uplink carrier aggregation (CA). In such examples, the UE may prune uplink grants such that a cumulative duty cycle across the carriers may be less than or equal to the advertised duty cycle. In some cases, the UE may be configured with a prioritization scheme that indicates how to prioritize which carriers for uplink transmission (e.g., based on grant size, based on carrier type, based on how data is multiplexed on a given carrier, or a combination thereof).

Additionally, or alternatively, the UE may be configured for multi-chain transmissions, where each chain may have a respective advertised duty cycle. As such, if the number of resources scheduled by the number of uplink grants over a configured time interval is above the configured advertised duty cycle, the UE may transmit a first set of uplink messages associated with a first subset of the uplink grants on a first transmission chain and transmit a second set of uplink messages associated with a second subset of the uplink grants on a second transmission chain. Performing a chain switching operation may satisfy the advertised duty cycle of each chain while operating in accordance with PC2 or PC1.5.

Aspects of the disclosure are initially described in the context of wireless communications systems. Aspects of the disclosure are further illustrated by and described with reference to process flows. Aspects of the disclosure are further illustrated by and described with reference to apparatus diagrams, system diagrams, and flowcharts that relate to variable uplink grant configurations for high power class devices.

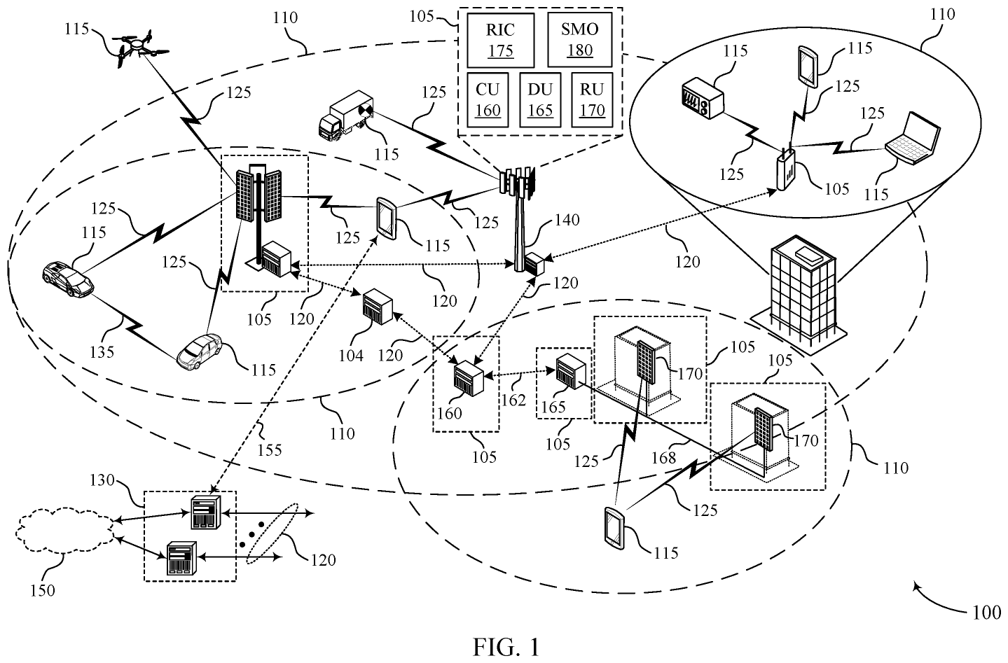

FIG. 1 illustrates an example of a wireless communications system 100 that supports variable uplink grant configurations for high power class devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support variable uplink grant configurations for high power class devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum, and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may decrease instances of PC fallback (e.g., from PC2 or PC1.5 to PC3) by operating in accordance with the techniques described herein. For example, the UE 115 may check the uplink scheduling and identify if the scheduled uplink exceeds the advertised uplink duty cycle. The UE 115 may further check if the UE 115 is operating in a far cell condition or if transmission power levels below a configured threshold. Additionally, or alternatively, the UE 115 may check if the amount of uplink BLER associated with PC3 operations exceeds a configurable threshold. If the UE 115 is in far cell conditions or if the BLER exceeds the configured threshold, the UE 115 may maintain uplink transmissions at PC2 or PC1.5. As such, if the difference between the scheduled uplink duty cycle and advertised duty cycle is below a configurable threshold, the UE 115 may refrain from transmitting (e.g., prune) one or more uplink messages scheduled by one or more of the uplink grants such that the scheduled uplink duty cycle may be less than or equal to the advertised uplink duty cycle. In some examples, the UE 115 may operate in accordance with uplink CA. In such examples, the UE 115 may refrain from transmitting one or more uplink messages scheduled by one or more uplink grants such that the number of scheduled resources in use across the carriers for a configured time interval has cumulative uplink duty cycle less than or equal to the advertised duty cycle. In some cases, the UE 115 may receive a control signal indicating how to prioritize which carriers for uplink transmission.

Additionally, or alternatively, the UE 115 may be configured for multi-chain transmissions, where each chain may have a respective advertised duty cycle. As such, if the number of resources scheduled by the set uplink grants during a configured time interval is above the configured advertised duty cycle, the UE 115 may transmit a first set of uplink messages associated with a first subset of the uplink grants on a first transmission chain and transmit a second set of uplink messages associated with a second subset of the uplink grants on a second transmission chain. Perfuming a chain switching operation may satisfy the advertised duty cycle of each chain while operating in accordance with PC2 or PC1.5.

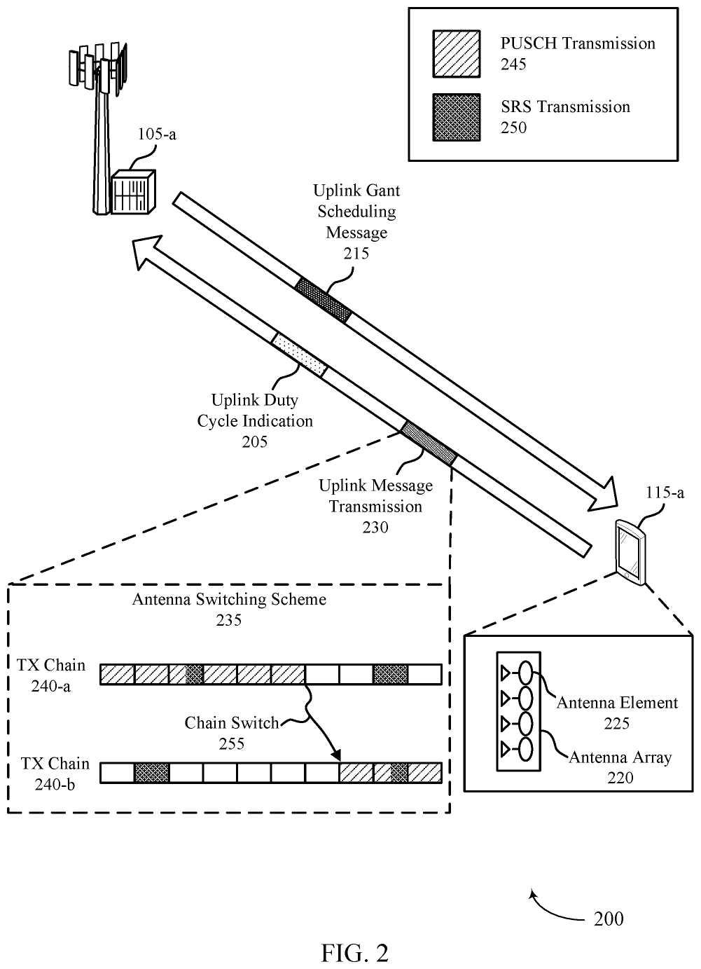

FIG. 2 illustrates an example of a wireless communications system 200 that supports variable uplink grant configurations for high power class devices in accordance with one or more aspects of the present disclosure. In some examples, wireless communications system 200 may implement one or more aspects of wireless communications system 100. For instance, a UE 115-a and a network entity 105-a may be respective examples of a UE 115 and a network entity 105 as described with reference to FIG. 1. While examples are discussed herein, any number of devices and device types may be used to accomplish implementations described in the present disclosure.

In some examples, of wireless communications system 200, the UE 115-a and network entity 105-a may communicate in accordance with 4G and 5G wireless communications technology. In some cases, such communications may have an associated higher bandwidth of operation. The higher bandwidth may result in the UE 115-a using a greater transmission power output to maintain a threshold PSD. As such, the UE 115-a may operate in accordance with a higher PC operation. For example, the UE 115-a may operate in accordance with PC2 (e.g., 26 dbm transmission power level) or PC1.5 (e.g., 29 dbm transmission power level) which may provide a higher transmission power level for the UE 115-a compared to PC3 (e.g., 23 dbm transmission power level).

In some cases, however, operating in accordance with PC2 or PC1.5 may impose one or more challenges at the UE 115-a. For example, thermal effects (e.g., an increase in temperature at the UE 115-a) may restrict or prohibit continuous operation at higher power levels. Additionally or alternatively, power operation associated with PC2 and PC1.5 may result in gain drop at the power amplifier of the UE 115-a in cases of back-to-back uplink scheduling. To mitigate the effects of high power level uplink transmissions, the UE 115-a may advertise a maximum uplink duty cycle supported by the UE 115-a for a given radio frequency band or a set of radio frequency bands for PC2 and PC1.5. For example, the UE 115-a may transmit to the network entity 105-a an uplink duty cycle indication 205 which may include an advertised duty cycle that indicates a threshold of uplink resources that may be scheduled at the UE 115-a for a configured time interval. As such, if a scheduled uplink duty cycle from the network entity 105-a exceeds the advertised duty cycle, the UE 115-a may transition from PC2 or PC1.5 operation to PC3 and continue operation.

In some examples, the uplink duty cycle indication 205 may include a first field that indicates a maximum number of symbols during a time interval that may be scheduled for uplink transmission (e.g., maxUplinkDutyCycle-PC2-FR1). In such examples, the first field may be applicable of frequency 1 (FR1) PC2 operations at the UE 115-a. If the first field is absent a 50% duty cycle may be applied.

In some examples, the uplink duty cycle indication 205 may include a second field that indicates a maximum number of symbols during a time interval that may be scheduled for uplink transmission (e.g., maxUplinkDutyCycle-PCIdot5-MPE-FR1). In such examples, the second field may be applicable of FR1 PC1.5 operations at the UE 115-a. If the second field is absent, the UE 115-a may mitigate maximum permissible exposure (MPE) autonomously by performing a maximum power reduction (e.g., transition from PC1.5 to PC3).

In some examples, the uplink duty cycle indication 205 may include a third field that indicates a maximum average percentage of symbols during a time interval that may be scheduled for uplink transmission (e.g., maxUplinkDutyCycle-interBandCA-PC2). In such examples, the third field may be applicable for PC2 over an aggregate of carriers in operation at the UE 115-a. If the third field is absent, the UE 115-a may operate in accordance with PC2 regardless of the advertised uplink duty cycle.

If the UE 115-a transitions from PC2 to PC3 the max power capability of the UE 115-a may decrease (e.g., from 26 dbm to 23 dbm) for bands that support PC2. If the UE 115-a transitions from PC1.5 to PC3 the max power capability of the UE 115-a may decrease (e.g., from 29 dbm to 23 dbm) for bands that support PC1.5. In some examples, a decrease in the max power capability of the UE 115-a may result in inconsistent wireless communications. For example, in higher frequency TDD bands operating at higher bandwidth, a fallback to PC3 may increase uplink BLER and result in uplink channel CRC failures. The increase in BLER and CRC failures may result in RLF, which may impact the user experience.

As such, the UE 115-a may decrease instances of PC3 fallback by operating in accordance with the techniques described herein. For example, the UE 115-a may receive an uplink grant scheduling message 215, which may indicate a set of uplink grants associated with a time interval. In some cases, the quantity of transmissions resources scheduled by the set of uplink grants may exceed the uplink transmission duty cycle of the UE 115-a for PC2 or PC1.5 operations. In some examples of the resources scheduled exceeding the uplink duty cycle, the UE 115-a may transition from PC2 or PC1.5 to PC3. While operating in accordance with PC3, the UE 115-a may check if the UE 115-a is operating in a far cell condition or experiencing a transmission power level below a configured threshold. For example, the UE 115-a and network entity 105-a may communicate one or more uplink signals to determine a distance between the network entity 105-a and the UE 115-a. If the distance exceeds a configured threshold, the UE 115-a may determine to transition back to PC2 or PC1.5. Additionally or alternatively, the UE 115-a may identify an amount of uplink BLER after transitioning to PC3. If the uplink BLER exceeds a configurable threshold (e.g., 50% based on profiling), the UE 115-a may transition back to PC2 or PC1.5.

If the difference between the scheduled uplink duty cycle associated with uplink scheduling message 215 and the advertised duty cycle of the UE 115-a is below a configurable threshold, the UE 115-a may refrain from transmitting one or more uplink messages associated with one or more of the set of uplink grants (e.g., perform uplink grant pruning). For example, during an uplink transmission 230, the UE 115-a may transmit using PC2 or PC1.5, a subset of uplink messages associated with a subset of the set of uplink grants such that the advertised uplink duty cycle of the UE 115-a is satisfied during the time interval. If, for instance, the advertised duty cycle for the UE 115-a is 40% of the symbol periods, and the uplink grant scheduling message 215 schedules three uplink grants where each grant schedules 15% of the symbol periods during a time interval, then the duty cycle associated with scheduled number of symbol periods may be greater than the advertised duty cycle of the UE 115-a for the high PC mode. In such instances, the UE 115-a may ignore one of the scheduled grants and transmit on a subset of the scheduled symbol periods (e.g., 30% of the symbol periods within the time interval), as part of the uplink message transmission 230, to satisfy the 40% advertised uplink duty cycle.

By transmitting the subset of uplink messages in the uplink message transmission 230, the UE 115-a may maintain operation at PC2 or PC1.5 while in a far cell condition. By maintaining operation in PC2 or PC1.5, the UE 115-a may reduce the uplink BLER (e.g., by 40%-80%) and decrease the occurrence of RLF for the wireless communications system 200.

In some examples, the wireless communications system may support carrier aggregation. For instance, the UE 115-a may communicate with the network entity 105-a using multiple carriers. In such examples, the uplink grant scheduling message 215 may indicate a set of uplink grants associated with one or more carriers in use at the UE 115-a. As such, the UE 115-a may transition from PC2 or PC1.5 to PC3 if a cumulative duty cycle across the multiple carriers exceeds the advertised duty cycle of the UE 115-a. To avoid transition to PC3, the UE 115-a may determine transmit a subset uplink messages associated with a subset of the set of uplink grants such that the cumulative duty cycle across carriers is below the advertised duty cycle of the UE 115-a. If, for instance, the advertised duty cycle for the UE 115-a is 40%, and the uplink grant scheduling message 215 schedules three uplink grants, across two or more carriers, where each grant schedules 15% of resources during a time interval, then the cumulative duty cycle associated with scheduled number of resources across the two or more carriers may be greater than the advertised duty cycle of the UE 115-a for the high PC mode. In such instances, the UE 115-a may ignore one of the scheduled grants from a given carrier and transmit 30% of the resources across the two or more carriers, as part of the uplink message transmission 230, to satisfy the 40% advertised duty cycle.

In some examples, the UE 115-a may determine which uplink grants to transmit messages for based on the one or more characteristics of the carriers in use and the uplink grants. For example, the UE 115-a may be configured with a set of conditions identifying which uplink grants to use, and which grants to ignore, such that the uplink transmissions by the UE 115-a satisfy the advertised uplink duty cycle without falling back to a lower power class.

In some examples, the UE 115-a may be configured to prioritize transmitting uplink messages for carriers based on the size of resources scheduled by the associated uplink grant (e.g., the number of scheduled symbols). For example, the uplink grant scheduling message 215 may include a first uplink grant and a second uplink grant of the set of uplink grants, where the UE 115-a may prioritize the first uplink grant based on the first uplink grant indicating a resource allocation that is larger than a second resource allocation of the second uplink grant. In some examples, the UE may be configured to prioritize a grant based on the associated bandwidth scheduled by the grant, the number of resources blocks scheduled by the grant, the modulation and coding scheme (MCS) indicated by the scheduled by the grant, or a combination thereof, so that a first grant corresponding to the largest resource allocation is prioritized over second grant that provides a relatively smaller resources allocation. As such, the UE 115-a may drop transmission of one or more uplink messages associated with grants scheduling transmission in relatively smaller resources, when pruning grants and corresponding transmissions for complying with the advertised duty cycle.

Additionally or alternatively, the UE 115-a may be configured to prioritize transmitting uplink messages based on the type of carrier an uplink grant is associated with. For example, the uplink grant scheduling message 215 may include a first uplink grant that indicates a first resource allocation on a primary component carrier (PCC) and second uplink grant that indicates a second resource allocation on a secondary component carrier (SCC). As such, the UE 115-a may be configured to prioritize transmitting a first uplink message scheduled by the first uplink grant based on the first uplink grant being associated with a PCC, when determining which one or more grants to prune for complying with the advertised duty cycle. Conversely, the UE 115-a may drop transmission of one or more uplink messages associated with grants scheduling transmission on the SCC, when pruning grants and corresponding transmissions for complying with the advertised duty cycle.

In some examples, the UE 115-a may be configured to prioritize transmitting uplink messages based on the type of data associated with a given carrier. For example, the uplink grant scheduling message 215 may include a first uplink grant that indicates a first resource allocation on a first carrier for transmitting first data and a second uplink grant that indicates a second resource allocation on a second carrier for transmission of second data. In such examples, the first data on the first carrier may include a physical uplink shared channel (PUSCH) multiplexed with uplink control information (UCI) (e.g., via a physical uplink control channel (PUCCH)) and the second data on the second data may include a non-multiplexed UCI. As such, the UE 115-a to prioritize the first uplink message in accordance with the configuration to prioritize multiplexed data, when determining which one or more grants to prune for complying with the advertised duty cycle. Conversely, the UE 115-a may drop transmission of one or more uplink messages that only include uplink data, without control information, when pruning grants and corresponding transmissions for complying with the advertised duty cycle.

In some implementations of wireless communications system 200, the UE 115-a may support MIMO transmissions. For example, the UE 115-a may include an antenna array 220, which may include one or more antenna elements 225. In some examples, each antenna element 225 may be configured to communicate data concurrently on respective transmission chains 240, where each transmission chain 240 may be associated with respective analog and digital components of the UE 115-a used for generating and communicating data with the network entity 105-a. In some cases, the UE 115-a may be configured with an antenna switching scheme 235, in which a first stream of data is switched from communication on a first antenna element 225 to communication on a second antenna element 225. For example, TDD stand-alone (SA) bands may support and advertise configuration for sounding reference signal (SRS) switching (e.g., for a two transmitter/four receiver (2T4R) antenna configuration). As such, the UE 115-a may identify if the UE 115-a has advertised support for 2T4R SRS antenna operation, and further identify if the uplink grant scheduling message 215 is configured for single-input/single-output (SISO) scheduling. If the uplink grant scheduling message 215 configures the set of uplink grants for SISO scheduling, then in a first antenna element 225 may transmit uplink messages associated with the uplink grants using a first transmission chain 240 and a second antenna element 225 may transmit SRS signaling using a second transmission chain 240.

In some cases, each transmission chain 240 may have a respective advertised uplink duty cycle (e.g., indicated in the uplink duty cycle indication 205). As such, if the duty cycle associated with the uplink grant scheduling message 215 exceeds the advertised duty cycle for a first transmission chain 240, the UE 115-a may switch to a second transmission chain 240 and continue uplink transmissions at PC2 or PC1.5. For example, as illustrated in FIG. 2, the UE 115-a may perform a first portion of the uplink message transmission 230 using transmission chain 240-a, where the UE 115-a may transmit a first portion of PUSCH transmissions 245 associated with a first subset of uplink grants from the set of uplink grants scheduled at the UE 115-a. In some examples, the UE 115-a may concurrently transmit SRS transmissions 250 on transmission chain 240-b. Based on the PUSCH transmissions 245 occurring more frequently than the SRS transmissions 250, the duty cycle associated with transmission chain 240-a may be greater than the duty cycle associated with transmission chain 240-b. As such, during the uplink message transmission 230, the UE 115-a may perform a chain switch 255 in which the remaining portion of PUSCH transmission 245 associated with the remaining portion of uplink grants may be transmitted via transmission chain 240-b. That is, once the duty cycle for a first transmission chain exceeds the advertised uplink duty cycle of the first transmission chain 240, the UE 115-a may switch transmission to a second transmission chain 240 that is configured for non-SRS transmissions. As illustrated in FIG. 2, the UE 115-a may continue to perform sparse SRS transmission 250 on both transmission chain 240-a and 240-b.

By performing the chain switch 255, the UE 115-a may support up to twice the advertised duty cycle for a given transmission chain 240 and may maintain PC2 or PC1.5 transmission levels.

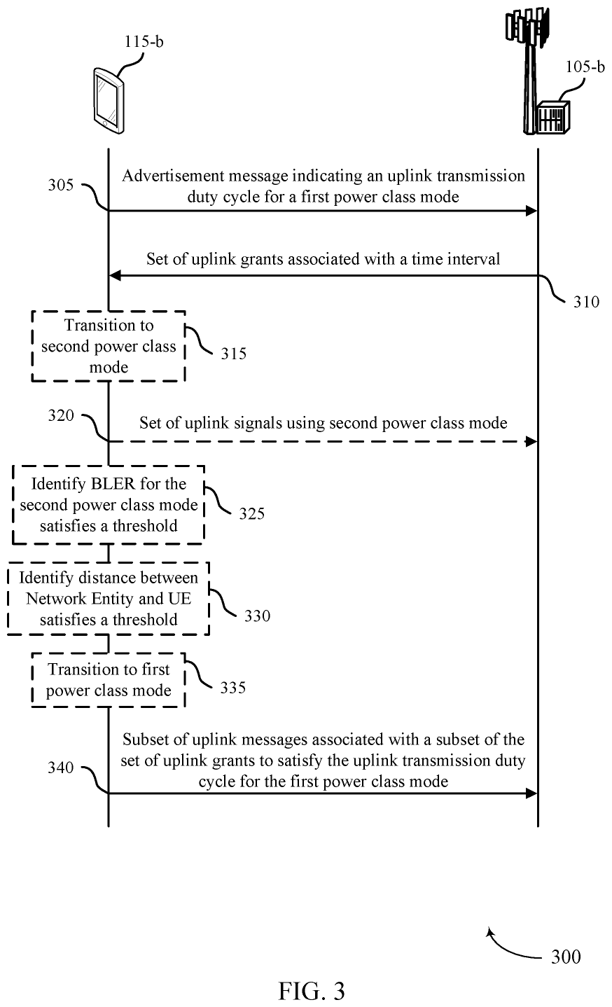

FIG. 3 illustrates an example of a process flow 300 that supports variable uplink grant configurations for high power class devices in accordance with one or more aspects of the present disclosure. In some examples, process flow 300 may implement aspects of wireless communications system 100 and wireless communications system 200. Process flow 300 includes a UE 115-b and a network entity 105-b which may be respective examples of a UE 115 and a network entity 105, as described with reference to FIGS. 1 and 2. Alternative examples of the following may be implemented, where some steps are performed in a different order than described or are not performed at all. In some cases, steps may include additional features not mentioned below, or further steps may be added. In addition, while process flow 300 shows processes between a single UE 115 and a single network entity 105, it should be understood that these processes may occur between any number of network devices and network device types.

At 305, the UE 115-b may transmit to the network entity 105-b, an advertisement message indicating an uplink transmission duty cycle associated with a first PC mode of the UE 115-b (e.g., PC2 or PC1.5). In some examples, the first PC mode of the UE 115-b may correspond to a higher transmission power level compared to a second PC mode of the UE 115-b (e.g., PC3).

At 310, the UE 115-b may receive from the network entity 105-b a set of uplink grants associated with a time interval. In some examples, a quantity of transmission resources scheduled by the set of uplink grants during the time interval may be associated with a duty cycle that exceeds the uplink transmission duty cycle associated with the first PC mode.

At 315, the UE 115-b may transition from the first PC mode to the second PC mode, based on the duty cycle of scheduled uplink grants exceeding the duty cycle associated with the first PC mode.

At 320, the UE 115-b may transmit, using the second PC mode, a set of uplink signals based on a second quantity of transmission resources scheduled during a second time interval exceeding the uplink transmission duty cycle associated with the first PC mode.

At 325, the UE 115-b may identify an uplink BLER associated with the second PC mode. In some examples, the UE 115-b may identify the BLER based on transmitting the set of uplink signals using the second PC mode, at 320. In some examples, the UE 115-b may identify that the UL BLER associated with the second PC mode satisfies a threshold (e.g., exceeds a configured BLER threshold). In some examples, the network entity 105-b may transmit to the UE 115-b, a control signal indicating the BLER threshold.

At 330, the UE 115-b may identify a distance between the UE 115-b and the network entity 105-b (e.g., via distance triangulation methods using a set of signals). In some examples, the UE 115-b may identify the distance based on transmitting the set of uplink signals using the second PC mode, at 320. Additionally, or alternatively, the UE 115-b may determine the distance based on communicating a set of signals with the network entity 105-b different from the set of signals, at 320. In some examples, the distance may satisfy a threshold (e.g., exceeds a configured distance threshold indicating that the UE 115-b may be operating in a far cell conidiation). In some examples, the network entity 105-b may transmit to the UE 115-b, a control signal indicating the distance threshold.

At 335, the UE 115-b may transition back from the second PC mode to the first PC mode. In some examples, the UE 115-b may determine to transition based on the distance satisfying the distance threshold, the BLER satisfying the BLER threshold, or a combination thereof.

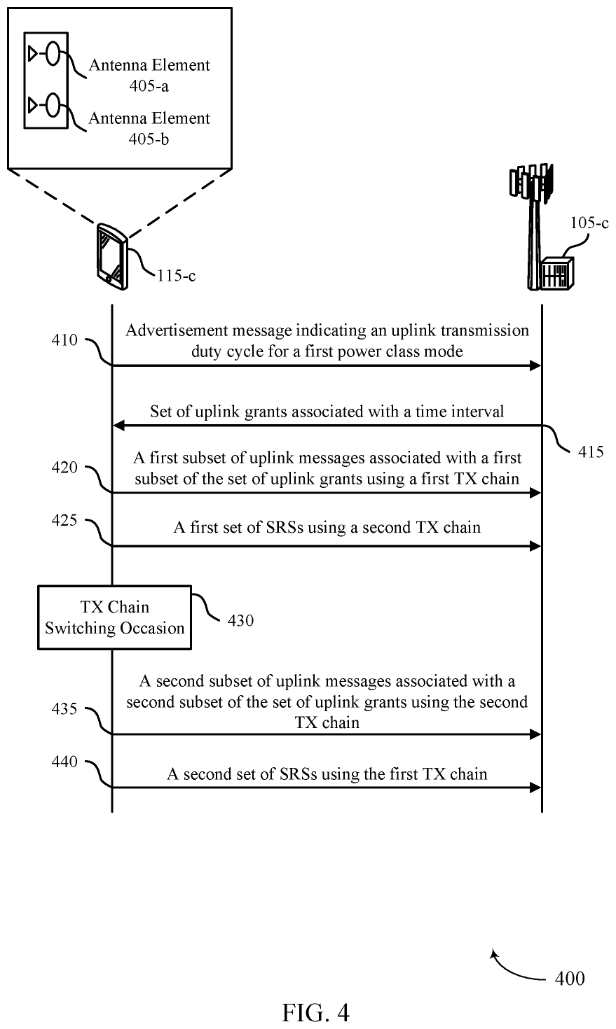

At 340, the UE 115-b may transmit using the first PC mode, a first subset of uplink messages associated with a first subset of the set of uplink grants to satisfy the uplink transmission duty cycle for the time interval based on dropping transmission of a second subset of uplink messages associated with a second subset of the set of uplink grants. In some examples, the UE 115-b may transmit the subset of the set of uplink grants based on the subset of the uplink messages being associated with single transmission chain transmission. If the UE is configured with multi-transmission chains, the UE may transmit a set of uplink messages associated with the full set of uplink grants. Further discussion of a UE operating in accordance with multi-transmission chains is described herein, including with reference to FIG. 4.

In some examples, the UE 115-b may determine which uplink grants to include in the subset of uplink grants based on being configured with a prioritization scheme for prioritization of transmission of uplink messages. For example, the UE 115-b may receive a first uplink grant and a second uplink grant of the set of uplink grants. As such, the subset of the uplink messages may include a first uplink message scheduled by the first uplink grant in accordance with the prioritization scheme indicating to prioritize the first uplink grant indicating a first resource allocation that is larger than a second resource allocation of the second uplink grant.

Additionally, or alternatively, the UE 115-b may receive a first uplink grant of the set of uplink grants that indicates a first resource allocation on a PCC and a second uplink grant of the set of uplink grants that indicates a second resource allocation on an SSC. As such, the subset of the uplink messages may include a first uplink message scheduled by the first uplink grant on the PCC in accordance with the prioritization scheme indicating to prioritize transmission via the PCC.

Additionally, or alternatively, the UE 115-b may receive a first uplink grant of the set of uplink grants that indicates a first resource allocation on a first carrier for transmission of UCI multiplexed with a first data and a second uplink grant of the set of uplink grants that indicates a second resource allocation on a second carrier for transmission of second data. As such, the subset of the uplink messages may include the UCI and the first data scheduled by the first uplink grant in accordance with a prioritization scheme indicating to prioritize multiplexing data with control information.

FIG. 4 illustrates an example of a process flow 400 that supports variable uplink grant configurations for high power class devices in accordance with one or more aspects of the present disclosure. In some examples, process flow 400 may implement aspects of wireless communications system 100, wireless communications system 200, and process flow 300. Process flow 400 includes a UE 115-c and a network entity 105-c which may be respective examples of a UE 115 and a network entity 105, as described with reference to FIGS. 1 through 3. Alternative examples of the following may be implemented, where some steps are performed in a different order than described or are not performed at all. In some cases, steps may include additional features not mentioned below, or further steps may be added. For example, the process flow 400 may include one or more steps described in process flow 300. In addition, while process flow 400 shows processes between a single UE 115 and a single network entity 105, it should be understood that these processes may occur between any number of network devices and network device types.

As illustrated in FIG. 4, the UE 115-c may be configured with multiple antenna elements 405 (e.g., antenna element 405-a and 405-b). In some examples, each antenna element 405 may be configured to communicate data concurrently on respective transmission chains. For instance, antenna element 405-a may transmit and receive data via a first transmission chain and antenna element 405-b may transmit and receive data via a second transmission chain. While FIG. 4 illustrates the UE 115-c including two antenna elements 405, it is understood that the UE 115-c may include any number of antenna elements 405 where each antenna element may be associated with a respective transmission chain.

At 410, the UE 115-c may transmit to a network entity 105-c, an advertisement message indicating an uplink transmission duty cycle associated with a first PC mode of the UE 115-c (e.g., PC2 or PC1.5). In some examples, the first PC mode of the UE 115-c may correspond to a higher transmission power level compared to a second PC mode of the UE 115-c (e.g., PC3). In some examples, each transmission chain may be associated with a respective uplink transmission duty cycle. In some examples, the respective uplink transmission duty cycles for the respective transmission chains may be the same or different.

At 415, the UE 115-c may receive from the network entity 105-c, a set of uplink grants associated with a time interval. In some examples, a quantity of transmission resources scheduled by the set of uplink grants during the time interval may exceed the uplink transmission duty cycle associated with a given transmission chain. In some examples, the UE 115-c may identify the set of uplink grants as being associated with a SISO transmission based on receiving the set of uplink grants.

At 420, the UE 115-c may transmit using the first PC mode on the first transmission chain of the UE 115-c, a first subset of uplink messages associated with a first subset of the set of uplink grants to satisfy the uplink transmission duty cycle for the first transmission chain during the time interval.

At 425, the UE 115-c may transmit during a first portion of the time interval, a first set of SRSs via the second transmission chain. In some examples, steps 420 and 425 may occur concurrently.

At 430, the UE 115-c may perform a transmission chain switching occasion in which data transmitted on the first transmission chain and data transmitted on the second transmission chain are switched for a second duration do the time interval. The UE 115-c may perform the switching occasion based on the first subset of uplink messages having a duty cycle satisfying (e.g., less than or equal to) the uplink transmission duty cycle for the first transmission chain during a first portion of the time interval.

At 435, the UE 115-c may transmit, using the first PC mode on the second transmission chain, a second subset of the uplink messages associated with a second subset of the set of uplink grants to satisfy the uplink transmission duty cycle for the second transmission chain during the time interval.

At 440, the UE 115-c may transmit during the second portion of the time interval, a second set of SRSs via the first transmission chain. In some examples, steps 435 and 440 may occur concurrently.

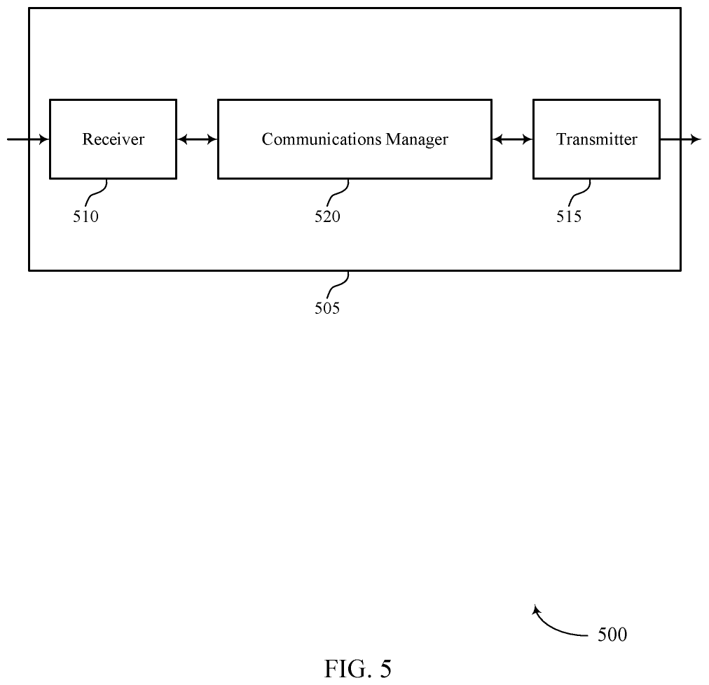

FIG. 5 shows a block diagram 500 of a device 505 that supports variable uplink grant configurations for high power class devices in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to variable uplink grant configurations for high power class devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to variable uplink grant configurations for high power class devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of variable uplink grant configurations for high power class devices as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for transmitting, to a network entity, an advertisement message indicating an uplink transmission duty cycle associated with a first power class mode of the UE, the first power class mode of the UE corresponding to a higher transmission power level than a second power class mode of the UE. The communications manager 520 may be configured as or otherwise support a means for receiving, from the network entity, a set of multiple uplink grants associated with a time interval, a quantity of transmission resources scheduled by the set of multiple uplink grants during the time interval exceeding the uplink transmission duty cycle associated with the first power class mode. The communications manager 520 may be configured as or otherwise support a means for transmitting, using the first power class mode, a first subset of uplink messages associated with a first subset of the set of multiple uplink grants to satisfy the uplink transmission duty cycle for the time interval based on dropping transmission of a second subset of uplink messages associated with a second subset of the set of multiple uplink grants.

Additionally, or alternatively, the communications manager 520 may support wireless communication at a UE in accordance with examples as disclosed herein. For example, the communications manager 520 may be configured as or otherwise support a means for transmitting, to a network entity, an advertisement message indicating an uplink transmission duty cycle associated with a first power class mode of the UE, the first power class mode of the UE corresponding to a higher transmission power level than a second power class mode of the UE. The communications manager 520 may be configured as or otherwise support a means for receiving, from the network entity, a set of multiple uplink grants associated with a time interval, a quantity of transmission resources scheduled by the set of multiple uplink grants during the time interval exceeding the uplink transmission duty cycle associated with the first power class mode. The communications manager 520 may be configured as or otherwise support a means for transmitting, using the first power class mode on a first transmission chain of the UE, a first subset of uplink messages associated with a first subset of the set of multiple uplink grants to satisfy the uplink transmission duty cycle for the first transmission chain during the time interval. The communications manager 520 may be configured as or otherwise support a means for transmitting, using the first power class mode on a second transmission chain of the UE, a second subset of the uplink messages associated with a second subset of the set of multiple uplink grants to satisfy the uplink transmission duty cycle for the second transmission chain during the time interval.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for increase transmission durations at higher PC levels resulting in a more efficient utilization of communication resources and reduced processing.

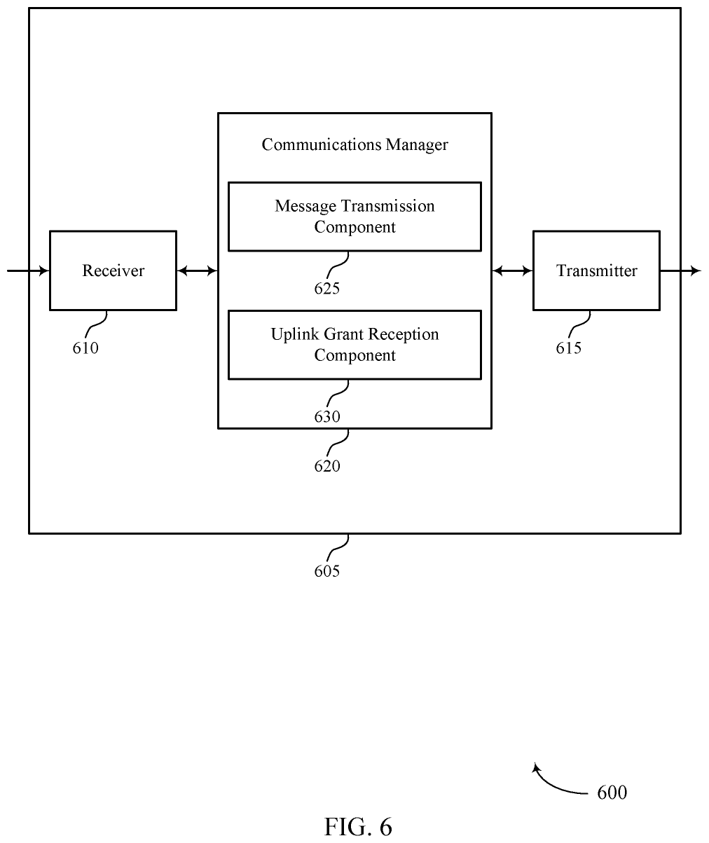

FIG. 6 shows a block diagram 600 of a device 605 that supports variable uplink grant configurations for high power class devices in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to variable uplink grant configurations for high power class devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to variable uplink grant configurations for high power class devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of variable uplink grant configurations for high power class devices as described herein. For example, the communications manager 620 may include a message transmission component 625 an uplink grant reception component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The message transmission component 625 may be configured as or otherwise support a means for transmitting, to a network entity, an advertisement message indicating an uplink transmission duty cycle associated with a first power class mode of the UE, the first power class mode of the UE corresponding to a higher transmission power level than a second power class mode of the UE. The uplink grant reception component 630 may be configured as or otherwise support a means for receiving, from the network entity, a set of multiple uplink grants associated with a time interval, a quantity of transmission resources scheduled by the set of multiple uplink grants during the time interval exceeding the uplink transmission duty cycle associated with the first power class mode. The message transmission component 625 may be configured as or otherwise support a means for transmitting, using the first power class mode, a first subset of uplink messages associated with a first subset of the set of multiple uplink grants to satisfy the uplink transmission duty cycle for the time interval based on dropping transmission of a second subset of uplink messages associated with a second subset of the set of multiple uplink grants.

Additionally, or alternatively, the communications manager 620 may support wireless communication at a UE in accordance with examples as disclosed herein. The message transmission component 625 may be configured as or otherwise support a means for transmitting, to a network entity, an advertisement message indicating an uplink transmission duty cycle associated with a first power class mode of the UE, the first power class mode of the UE corresponding to a higher transmission power level than a second power class mode of the UE. The uplink grant reception component 630 may be configured as or otherwise support a means for receiving, from the network entity, a set of multiple uplink grants associated with a time interval, a quantity of transmission resources scheduled by the set of multiple uplink grants during the time interval exceeding the uplink transmission duty cycle associated with the first power class mode. The message transmission component 625 may be configured as or otherwise support a means for transmitting, using the first power class mode on a first transmission chain of the UE, a first subset of uplink messages associated with a first subset of the set of multiple uplink grants to satisfy the uplink transmission duty cycle for the first transmission chain during the time interval. The message transmission component 625 may be configured as or otherwise support a means for transmitting, using the first power class mode on a second transmission chain of the UE, a second subset of the uplink messages associated with a second subset of the set of multiple uplink grants to satisfy the uplink transmission duty cycle for the second transmission chain during the time interval.

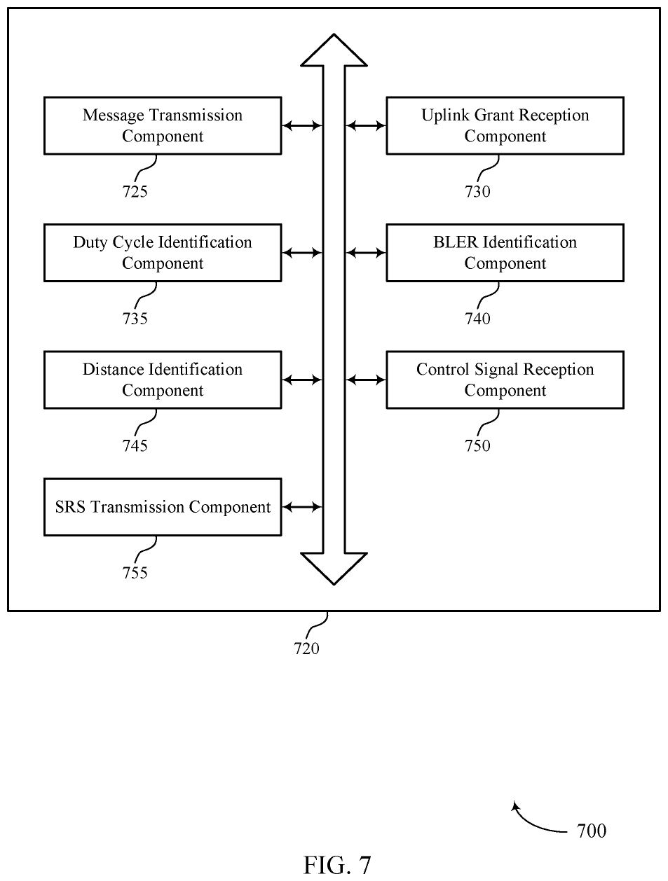

FIG. 7 shows a block diagram 700 of a communications manager 720 that supports variable uplink grant configurations for high power class devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of variable uplink grant configurations for high power class devices as described herein. For example, the communications manager 720 may include a message transmission component 725, an uplink grant reception component 730, a duty cycle identification component 735, a BLER identification component 740, a distance identification component 745, a control signal reception component 750, an SRS transmission component 755, or any combination thereof. Each of these components may communicate, directly or indirectly, with one another (e.g., via one or more buses).

The communications manager 720 may support wireless communications at a UE in accordance with examples as disclosed herein. The message transmission component 725 may be configured as or otherwise support a means for transmitting, to a network entity, an advertisement message indicating an uplink transmission duty cycle associated with a first power class mode of the UE, the first power class mode of the UE corresponding to a higher transmission power level than a second power class mode of the UE. The uplink grant reception component 730 may be configured as or otherwise support a means for receiving, from the network entity, a set of multiple uplink grants associated with a time interval, a quantity of transmission resources scheduled by the set of multiple uplink grants during the time interval exceeding the uplink transmission duty cycle associated with the first power class mode. In some examples, the message transmission component 725 may be configured as or otherwise support a means for transmitting, using the first power class mode, a first subset of uplink messages associated with a first subset of the set of multiple uplink grants to satisfy the uplink transmission duty cycle for the time interval based on dropping transmission of a second subset of uplink messages associated with a second subset of the set of multiple uplink grants.

In some examples, the duty cycle identification component 735 may be configured as or otherwise support a means for transmitting, using the second power class mode, a set of multiple uplink signals based on a second quantity of transmission resources scheduled during a second time interval exceeding the uplink transmission duty cycle associated with the first power class mode.

In some examples, to support transmitting the subset of the uplink messages, the BLER identification component 740 may be configured as or otherwise support a means for transmitting the subset of the uplink messages using the first power class mode based on a BLER associated the second power class mode satisfying a threshold.

In some examples, to support transmitting the subset of the uplink messages, the distance identification component 745 may be configured as or otherwise support a means for transmitting the subset of the uplink messages using the first power class mode based on a distance between the network entity and the UE satisfying a threshold.

In some examples, the distance identification component 745 may be configured as or otherwise support a means for communicating one or more uplink signals with the network entity to determine the distance between the network entity and the UE.

In some examples, the uplink grant reception component 730 may be configured as or otherwise support a means for receiving a first uplink grant and a second uplink grant of the set of multiple uplink grants, each of the first uplink grant and the second uplink grant being associated with a different carrier, where the first subset of the uplink messages includes a first uplink message scheduled by the first uplink grant in accordance with a prioritization scheme indicating to prioritize the first uplink grant indicating a first resource allocation that is larger than a second resource allocation of the second uplink grant.

In some examples, the uplink grant reception component 730 may be configured as or otherwise support a means for receiving a first uplink grant of the set of multiple uplink grants that indicates a first resource allocation on a primary component carrier and a second uplink grant of the set of multiple uplink grants that indicates a second resource allocation on a secondary component carrier, where the subset of the uplink messages includes a first uplink message scheduled by the first uplink grant on the primary component carrier in accordance with a prioritization scheme indicating to prioritize transmission via the primary component carrier.

In some examples, the uplink grant reception component 730 may be configured as or otherwise support a means for receiving a first uplink grant of the set of multiple uplink grants that indicates a first resource allocation on a first carrier for transmission of control information and first data and a second uplink grant of the set of multiple uplink grants that indicates a second resource allocation on a second carrier for transmission of second data, where the subset of the uplink messages includes the control information and the first data scheduled by the first uplink grant in accordance with a prioritization scheme indicating to prioritize multiplexing data with control information.

In some examples, the message transmission component 725 may be configured as or otherwise support a means for transmitting, using the first power class mode, the subset of the uplink messages associated with the subset of the set of multiple uplink grants based on the subset of the uplink messages being associated with single transmission chain transmission.

In some examples, the control signal reception component 750 may be configured as or otherwise support a means selecting the first subset and the second subset of the plurality of uplink grants based at least in part on a prioritization scheme for prioritization of transmission of uplink messages associated with the plurality of uplink grants.

Additionally, or alternatively, the communications manager 720 may support wireless communication at a UE in accordance with examples as disclosed herein. In some examples, the message transmission component 725 may be configured as or otherwise support a means for transmitting, to a network entity, an advertisement message indicating an uplink transmission duty cycle associated with a first power class mode of the UE, the first power class mode of the UE corresponding to a higher transmission power level than a second power class mode of the UE. In some examples, the uplink grant reception component 730 may be configured as or otherwise support a means for receiving, from the network entity, a set of multiple uplink grants associated with a time interval, a quantity of transmission resources scheduled by the set of multiple uplink grants during the time interval exceeding the uplink transmission duty cycle associated with the first power class mode. In some examples, the message transmission component 725 may be configured as or otherwise support a means for transmitting, using the first power class mode on a first transmission chain of the UE, a first subset of uplink messages associated with a first subset of the set of multiple uplink grants to satisfy the uplink transmission duty cycle for the first transmission chain during the time interval. In some examples, the message transmission component 725 may be configured as or otherwise support a means for transmitting, using the first power class mode on a second transmission chain of the UE, a second subset of the uplink messages associated with a second subset of the set of multiple uplink grants to satisfy the uplink transmission duty cycle for the second transmission chain during the time interval.

In some examples, the message transmission component 725 may be configured as or otherwise support a means for transmitting the first subset of the uplink messages on the first transmission chain and the second subset of the uplink messages on the second transmission chain based on the set of multiple uplink grants being associated with SISO transmission.

In some examples, the SRS transmission component 755 may be configured as or otherwise support a means for transmitting, during a first portion of the time interval, a first set of sounding reference signals via the second transmission chain and the first subset of the uplink messages via the first transmission chain. In some examples, the SRS transmission component 755 may be configured as or otherwise support a means for transmitting, during a second portion of the time interval, a second set of sounding reference signals via the first transmission chain and the second subset of the uplink messages via the second transmission chain.

In some examples, the duty cycle identification component 735 may be configured as or otherwise support a means for transmitting, using the first power class mode on the second transmission chain of the UE, the second subset of the uplink messages during a second portion of the time interval based on the first subset of uplink grants satisfying the uplink transmission duty cycle during a first portion of the time interval.

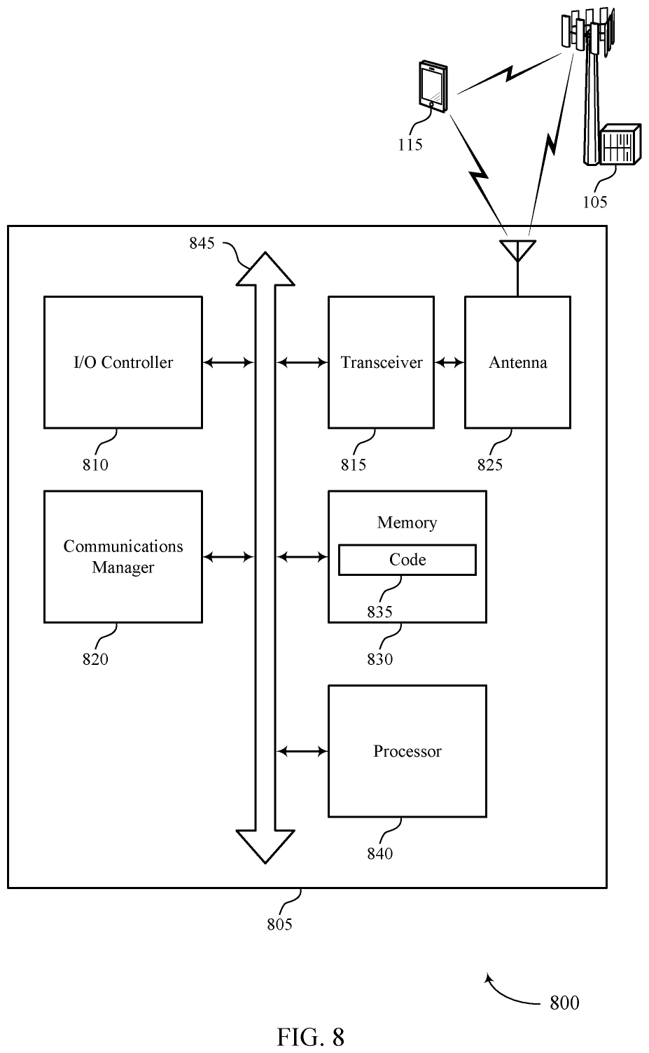

FIG. 8 shows a diagram of a system 800 including a device 805 that supports variable uplink grant configurations for high power class devices in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting variable uplink grant configurations for high power class devices). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for transmitting, to a network entity, an advertisement message indicating an uplink transmission duty cycle associated with a first power class mode of the UE, the first power class mode of the UE corresponding to a higher transmission power level than a second power class mode of the UE. The communications manager 820 may be configured as or otherwise support a means for receiving, from the network entity, a set of multiple uplink grants associated with a time interval, a quantity of transmission resources scheduled by the set of multiple uplink grants during the time interval exceeding the uplink transmission duty cycle associated with the first power class mode. The communications manager 820 may be configured as or otherwise support a means for transmitting, using the first power class mode, a first subset of uplink messages associated with a first subset of the set of multiple uplink grants to satisfy the uplink transmission duty cycle for the time interval based on dropping transmission of a second subset of uplink messages associated with a second subset of the set of multiple uplink grants.

Additionally, or alternatively, the communications manager 820 may support wireless communication at a UE in accordance with examples as disclosed herein. For example, the communications manager 820 may be configured as or otherwise support a means for transmitting, to a network entity, an advertisement message indicating an uplink transmission duty cycle associated with a first power class mode of the UE, the first power class mode of the UE corresponding to a higher transmission power level than a second power class mode of the UE. The communications manager 820 may be configured as or otherwise support a means for receiving, from the network entity, a set of multiple uplink grants associated with a time interval, a quantity of transmission resources scheduled by the set of multiple uplink grants during the time interval exceeding the uplink transmission duty cycle associated with the first power class mode. The communications manager 820 may be configured as or otherwise support a means for transmitting, using the first power class mode on a first transmission chain of the UE, a first subset of uplink messages associated with a first subset of the set of multiple uplink grants to satisfy the uplink transmission duty cycle for the first transmission chain during the time interval. The communications manager 820 may be configured as or otherwise support a means for transmitting, using the first power class mode on a second transmission chain of the UE, a second subset of the uplink messages associated with a second subset of the set of multiple uplink grants to satisfy the uplink transmission duty cycle for the second transmission chain during the time interval.

By including or configuring the communications manager 820 in accordance with examples as described herein, the device 805 may support techniques for increase transmission durations at higher PC levels resulting improved communication reliability, reduced latency, improved user experience related to reduced processing, more efficient utilization of communication resources, improved coordination between devices, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. For example, the communications manager 820 may be configured to receive or transmit messages or other signaling as described herein via the transceiver 815. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of variable uplink grant configurations for high power class devices as described herein, or the processor 840 and the memory 830 may be otherwise configured to perform or support such operations.

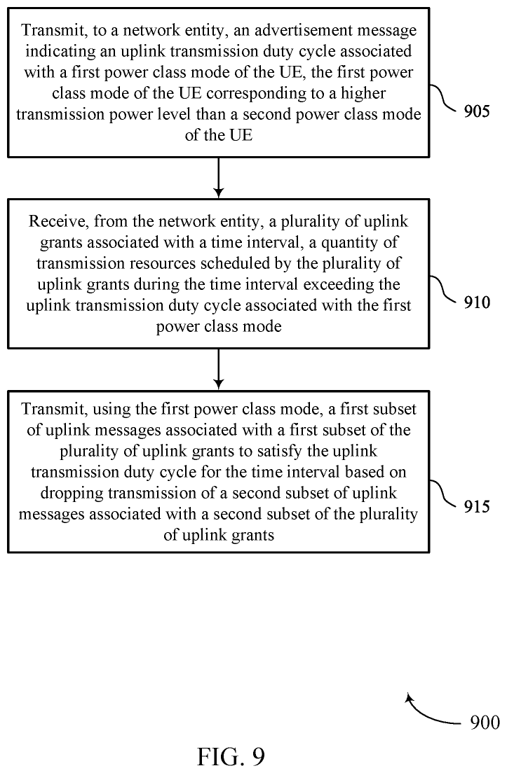

FIG. 9 shows a flowchart illustrating a method 900 that supports variable uplink grant configurations for high power class devices in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include transmitting, to a network entity, an advertisement message indicating an uplink transmission duty cycle associated with a first power class mode of the UE, the first power class mode of the UE corresponding to a higher transmission power level than a second power class mode of the UE. The operations of 905 may be performed in accordance with examples as disclosed herein. In some examples, aspects of the operations of 905 may be performed by a message transmission component 725 as described with reference to FIG. 7.

At 910, the method may include receiving, from the network entity, a set of multiple uplink grants associated with a time interval, a quantity of transmission resources scheduled by the set of multiple uplink grants during the time interval exceeding the uplink transmission duty cycle associated with the first power class mode. The operations of 910 may be performed in accordance with examples as disclosed herein. In some examples, aspects of the operations of 910 may be performed by an uplink grant reception component 730 as described with reference to FIG. 7.

At 915, the method may include transmitting, using the first power class mode, a first subset of uplink messages associated with a first subset of the set of multiple uplink grants to satisfy the uplink transmission duty cycle for the time interval based at least in part on dropping transmission of a second subset of uplink messages associated with a second subset of the set of multiple uplink grants. The operations of 915 may be performed in accordance with examples as disclosed herein. In some examples, aspects of the operations of 915 may be performed by a message transmission component 725 as described with reference to FIG. 7.

In some examples, the method may further include receiving a set of multiple uplink grants, each of the first uplink grant and the second uplink grant being associated with a different carrier, where the first subset of the uplink messages may include a first uplink message scheduled by the first uplink grant in accordance with a prioritization scheme indicating to prioritize the first uplink grant indicating a first resource allocation that is larger than a second resource allocation of the second uplink grant.

Additionally or alternatively, the method may further include receiving a first uplink grant of the set of multiple uplink grants that indicates a first resource allocation on a primary component carrier and a second uplink grant of the set of multiple uplink grants that indicates a second resource allocation on a secondary component carrier, where the first subset of the uplink messages may include a first uplink message scheduled by the first uplink grant on the primary component carrier in accordance with a prioritization scheme indicating to prioritize transmission via the primary component carrier.

Additionally or alternatively, the method may further include receiving a first uplink grant of the set of multiple uplink grants that indicates a first resource allocation on a first carrier for transmission of control information and first data and a second uplink grant of the set of multiple uplink grants that indicates a second resource allocation on a second carrier for transmission of second data, where the first subset of the uplink messages may include the control information and the first data scheduled by the first uplink grant in accordance with a prioritization scheme indicating to prioritize multiplexing data with control information.

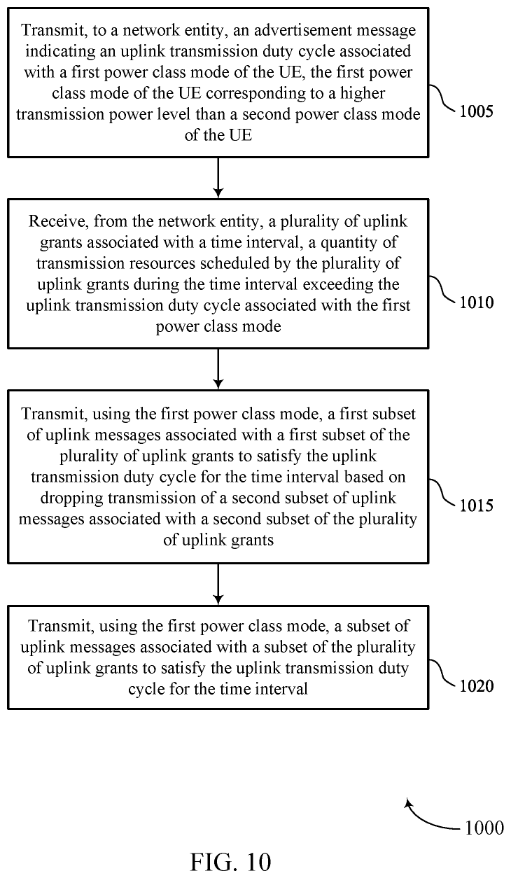

FIG. 10 shows a flowchart illustrating a method 1000 that supports variable uplink grant configurations for high power class devices in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting, to a network entity, an advertisement message indicating an uplink transmission duty cycle associated with a first power class mode of the UE, the first power class mode of the UE corresponding to a higher transmission power level than a second power class mode of the UE. The operations of 1005 may be performed in accordance with examples as disclosed herein. In some examples, aspects of the operations of 1005 may be performed by a message transmission component 725 as described with reference to FIG. 7.

At 1010, the method may include receiving, from the network entity, a set of multiple uplink grants associated with a time interval, a quantity of transmission resources scheduled by the set of multiple uplink grants during the time interval exceeding the uplink transmission duty cycle associated with the first power class mode. The operations of 1010 may be performed in accordance with examples as disclosed herein. In some examples, aspects of the operations of 1010 may be performed by an uplink grant reception component 730 as described with reference to FIG. 7.

At 1015, the method may include transmitting, using the second power class mode, a set of multiple uplink signals based on a second quantity of transmission resources scheduled during a second time interval exceeding the uplink transmission duty cycle associated with the first power class mode. The operations of 1015 may be performed in accordance with examples as disclosed herein. In some examples, aspects of the operations of 1015 may be performed by a duty cycle identification component 735 as described with reference to FIG. 7.

At 1020, the method may include transmitting, using the first power class mode, a first subset of uplink messages associated with a first subset of the a set of multiple uplink grants to satisfy the uplink transmission duty cycle for the time interval based at least in part on dropping transmission of a second subset of uplink messages associated with a second subset of the set of multiple of uplink grants. The operations of 1020 may be performed in accordance with examples as disclosed herein. In some examples, aspects of the operations of 1020 may be performed by a message transmission component 725 as described with reference to FIG. 7.

In some examples, the method may further include receiving a set of multiple uplink grants, each of the first uplink grant and the second uplink grant being associated with a different carrier, where the first subset of the uplink messages may include a first uplink message scheduled by the first uplink grant in accordance with a prioritization scheme indicating to prioritize the first uplink grant indicating a first resource allocation that is larger than a second resource allocation of the second uplink grant.

Additionally or alternatively, the method may further include receiving a first uplink grant of the set of multiple uplink grants that indicates a first resource allocation on a primary component carrier and a second uplink grant of the set of multiple uplink grants that indicates a second resource allocation on a secondary component carrier, where the first subset of the uplink messages may include a first uplink message scheduled by the first uplink grant on the primary component carrier in accordance with a prioritization scheme indicating to prioritize transmission via the primary component carrier.

Additionally or alternatively, the method may further include receiving a first uplink grant of the set of multiple uplink grants that indicates a first resource allocation on a first carrier for transmission of control information and first data and a second uplink grant of the set of multiple uplink grants that indicates a second resource allocation on a second carrier for transmission of second data, where the first subset of the uplink messages may include the control information and the first data scheduled by the first uplink grant in accordance with a prioritization scheme indicating to prioritize multiplexing data with control information.

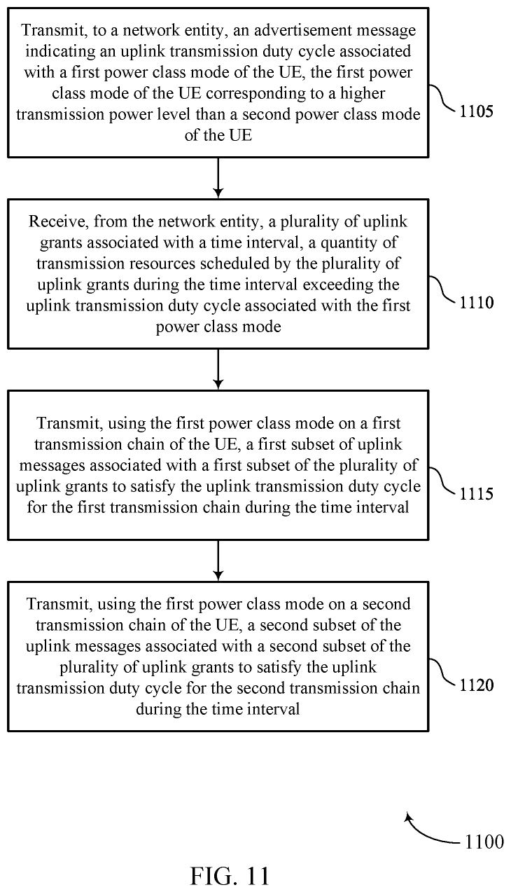

FIG. 11 shows a flowchart illustrating a method 1100 that supports variable uplink grant configurations for high power class devices in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include transmitting, to a network entity, an advertisement message indicating an uplink transmission duty cycle associated with a first power class mode of the UE, the first power class mode of the UE corresponding to a higher transmission power level than a second power class mode of the UE. The operations of 1105 may be performed in accordance with examples as disclosed herein. In some examples, aspects of the operations of 1105 may be performed by a message transmission component 725 as described with reference to FIG. 7.

At 1110, the method may include receiving, from the network entity, a set of multiple uplink grants associated with a time interval, a quantity of transmission resources scheduled by the set of multiple uplink grants during the time interval exceeding the uplink transmission duty cycle associated with the first power class mode. The operations of 1110 may be performed in accordance with examples as disclosed herein. In some examples, aspects of the operations of 1110 may be performed by an uplink grant reception component 730 as described with reference to FIG. 7.

At 1115, the method may include transmitting, using the first power class mode on a first transmission chain of the UE, a first subset of uplink messages associated with a first subset of the set of multiple uplink grants to satisfy the uplink transmission duty cycle for the first transmission chain during the time interval. The operations of 1115 may be performed in accordance with examples as disclosed herein. In some examples, aspects of the operations of 1115 may be performed by a message transmission component 725 as described with reference to FIG. 7.

At 1120, the method may include transmitting, using the first power class mode on a second transmission chain of the UE, a second subset of the uplink messages associated with a second subset of the set of multiple uplink grants to satisfy the uplink transmission duty cycle for the second transmission chain during the time interval. The operations of 1120 may be performed in accordance with examples as disclosed herein. In some examples, aspects of the operations of 1120 may be performed by a message transmission component 725 as described with reference to FIG. 7.

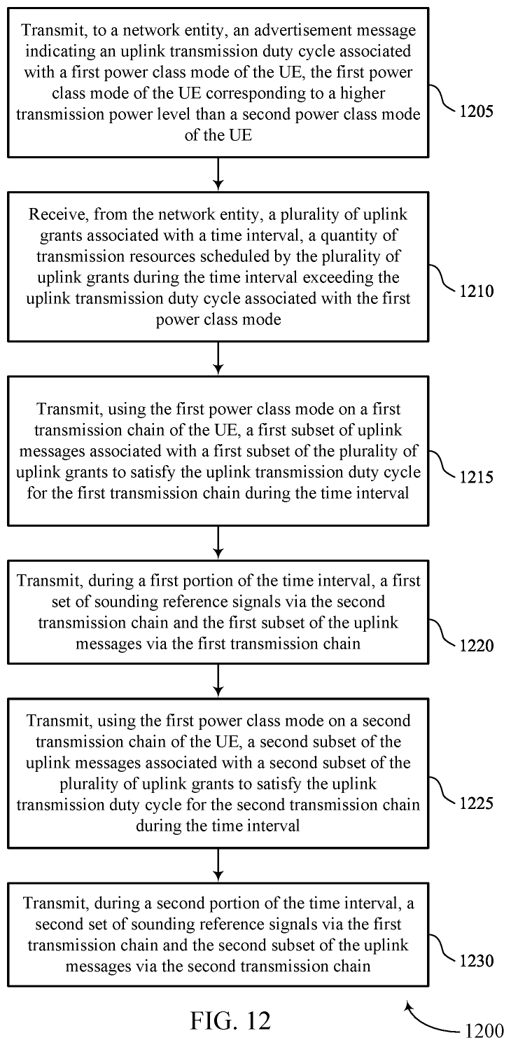

FIG. 12 shows a flowchart illustrating a method 1200 that supports variable uplink grant configurations for high power class devices in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include transmitting, to a network entity, an advertisement message indicating an uplink transmission duty cycle associated with a first power class mode of the UE, the first power class mode of the UE corresponding to a higher transmission power level than a second power class mode of the UE. The operations of 1205 may be performed in accordance with examples as disclosed herein. In some examples, aspects of the operations of 1205 may be performed by a message transmission component 725 as described with reference to FIG. 7.

At 1210, the method may include receiving, from the network entity, a set of multiple uplink grants associated with a time interval, a quantity of transmission resources scheduled by the set of multiple uplink grants during the time interval exceeding the uplink transmission duty cycle associated with the first power class mode. The operations of 1210 may be performed in accordance with examples as disclosed herein. In some examples, aspects of the operations of 1210 may be performed by an uplink grant reception component 730 as described with reference to FIG. 7.

At 1215, the method may include transmitting, using the first power class mode on a first transmission chain of the UE, a first subset of uplink messages associated with a first subset of the set of multiple uplink grants to satisfy the uplink transmission duty cycle for the first transmission chain during the time interval. The operations of 1215 may be performed in accordance with examples as disclosed herein. In some examples, aspects of the operations of 1215 may be performed by a message transmission component 725 as described with reference to FIG. 7.

At 1220, the method may include transmitting, during a first portion of the time interval, a first set of sounding reference signals via the second transmission chain and the first subset of the uplink messages via the first transmission chain. The operations of 1220 may be performed in accordance with examples as disclosed herein. In some examples, aspects of the operations of 1220 may be performed by an SRS transmission component 755 as described with reference to FIG. 7.

At 1225, the method may include transmitting, using the first power class mode on a second transmission chain of the UE, a second subset of the uplink messages associated with a second subset of the set of multiple uplink grants to satisfy the uplink transmission duty cycle for the second transmission chain during the time interval. The operations of 1225 may be performed in accordance with examples as disclosed herein. In some examples, aspects of the operations of 1225 may be performed by a message transmission component 725 as described with reference to FIG. 7.

At 1230, the method may include transmitting, during a second portion of the time interval, a second set of sounding reference signals via the first transmission chain and the second subset of the uplink messages via the second transmission chain. The operations of 1230 may be performed in accordance with examples as disclosed herein. In some examples, aspects of the operations of 1230 may be performed by an SRS transmission component 755 as described with reference to FIG. 7.

The following provides an overview of aspects of the present disclosure:

Aspect 1: A method for wireless communications at a UE, comprising: transmitting, to a network entity, an advertisement message indicating an uplink transmission duty cycle associated with a first power class mode of the UE, the first power class mode of the UE corresponding to a higher transmission power level than a second power class mode of the UE; receiving, from the network entity, a plurality of uplink grants associated with a time interval, a quantity of transmission resources scheduled by the plurality of uplink grants during the time interval exceeding the uplink transmission duty cycle associated with the first power class mode; and transmitting, using the first power class mode, a first subset of uplink messages associated with a first subset of the plurality of uplink grants to satisfy the uplink transmission duty cycle for the time interval based at least in part on dropping transmission of a second subset of uplink messages associated with a second subset of the plurality of uplink grants.

Aspect 2: The method of aspect 1, further comprising: transmitting, using the second power class mode, a plurality of uplink signals based at least in part on a second quantity of transmission resources scheduled during a second time interval exceeding the uplink transmission duty cycle associated with the first power class mode.

Aspect 3: The method of any of aspects 1 through 2, wherein transmitting the first subset of the uplink messages further comprises: transmitting the first subset of the uplink messages using the first power class mode based at least in part on a BLER associated the second power class mode satisfying a threshold.

Aspect 4: The method of any of aspects 1 through 3, further comprising: receiving a first uplink grant and a second uplink grant of the plurality of uplink grants, each of the first uplink grant and the second uplink grant being associated with a different carrier, wherein the first subset of the uplink messages comprises a first uplink message scheduled by the first uplink grant in accordance with a prioritization scheme indicating to prioritize the first uplink grant indicating a first resource allocation that is larger than a second resource allocation of the second uplink grant.

Aspect 5: The method of any of aspects 1 through 4, further comprising: receiving a first uplink grant of the plurality of uplink grants that indicates a first resource allocation on a primary component carrier and a second uplink grant of the plurality of uplink grants that indicates a second resource allocation on a secondary component carrier, wherein the first subset of the uplink messages comprises a first uplink message scheduled by the first uplink grant on the primary component carrier in accordance with a prioritization scheme indicating to prioritize transmission via the primary component carrier.

Aspect 6: The method of any of aspects 1 through 5, further comprising: receiving a first uplink grant of the plurality of uplink grants that indicates a first resource allocation on a first carrier for transmission of control information and first data and a second uplink grant of the plurality of uplink grants that indicates a second resource allocation on a second carrier for transmission of second data, wherein the first subset of the uplink messages comprises the control information and the first data scheduled by the first uplink grant in accordance with a prioritization scheme indicating to prioritize multiplexing data with control information.

Aspect 7: The method of any of aspects 1 through 6, further comprising: transmitting, using the first power class mode, the first subset of the uplink messages associated with the first subset of the plurality of uplink grants based at least in part on the first subset of the uplink messages being associated with single transmission chain transmission.

Aspect 8: The method of any of aspects 1 through 7, further comprising: selecting the first subset and the second subset of the plurality of uplink grants based at least in part on a prioritization scheme for prioritization of transmission of uplink messages associated with the plurality of uplink grants.

Aspect 9: A method for wireless communication at a UE, comprising: transmitting, to a network entity, an advertisement message indicating an uplink transmission duty cycle associated with a first power class mode of the UE, the first power class mode of the UE corresponding to a higher transmission power level than a second power class mode of the UE; receiving, from the network entity, a plurality of uplink grants associated with a time interval, a quantity of transmission resources scheduled by the plurality of uplink grants during the time interval exceeding the uplink transmission duty cycle associated with the first power class mode; transmitting, using the first power class mode on a first transmission chain of the UE, a first subset of uplink messages associated with a first subset of the plurality of uplink grants to satisfy the uplink transmission duty cycle for the first transmission chain during the time interval; and transmitting, using the first power class mode on a second transmission chain of the UE, a second subset of the uplink messages associated with a second subset of the plurality of uplink grants to satisfy the uplink transmission duty cycle for the second transmission chain during the time interval.

Aspect 10: The method of aspect 9, further comprising: transmitting the first subset of the uplink messages on the first transmission chain and the second subset of the uplink messages on the second transmission chain based at least in part on the plurality of uplink grants being associated with SISO transmission.

Aspect 11: The method of any of aspects 9 through 10, further comprising: transmitting, during a first portion of the time interval, a first set of sounding reference signals via the second transmission chain and the first subset of the uplink messages via the first transmission chain; and transmitting, during a second portion of the time interval, a second set of sounding reference signals via the first transmission chain and the second subset of the uplink messages via the second transmission chain.

Aspect 12: The method of any of aspects 9 through 11, further comprising: transmitting, using the first power class mode on the second transmission chain of the UE, the second subset of the uplink messages during a second portion of the time interval based at least in part on the first subset of uplink grants satisfying the uplink transmission duty cycle during a first portion of the time interval.

Aspect 13: An apparatus for wireless communications at a UE, comprising a processor; memory coupled with the processor; and instructions stored in the memory and executable by the processor to cause the apparatus to perform a method of any of aspects 1 through 8.

Aspect 14: An apparatus for wireless communications at a UE, comprising at least one means for performing a method of any of aspects 1 through 8.

Aspect 15: A non-transitory computer-readable medium storing code for wireless communications at a UE, the code comprising instructions executable by a processor to perform a method of any of aspects 1 through 8.

Aspect 16: An apparatus for wireless communication at a UE, comprising a processor; memory coupled with the processor; and instructions stored in the memory and executable by the processor to cause the apparatus to perform a method of any of aspects 9 through 12.

Aspect 17: An apparatus for wireless communication at a UE, comprising at least one means for performing a method of any of aspects 9 through 12.

Aspect 18: A non-transitory computer-readable medium storing code for wireless communication at a UE, the code comprising instructions executable by a processor to perform a method of any of aspects 9 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like.

Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting, to a network entity, an advertisement message indicating an uplink transmission duty cycle associated with a first power class mode of the UE, the first power class mode of the UE corresponding to a higher transmission power level than a second power class mode of the UE;
receiving, from the network entity, a plurality of uplink grants associated with a time interval, a quantity of transmission resources scheduled by the plurality of uplink grants during the time interval exceeding the uplink transmission duty cycle associated with the first power class mode; and
transmitting, using the first power class mode, a first subset of uplink messages associated with a first subset of the plurality of uplink grants to satisfy the uplink transmission duty cycle for the time interval based at least in part on dropping transmission of a second subset of uplink messages associated with a second subset of the plurality of uplink grants.

2. The method of claim 1, further comprising:
transmitting, using the second power class mode, a plurality of uplink signals based at least in part on a second quantity of transmission resources scheduled during a second time interval exceeding the uplink transmission duty cycle associated with the first power class mode.

3. The method of claim 1, wherein transmitting the first subset of the uplink messages further comprises:
transmitting the first subset of the uplink messages using the first power class mode based at least in part on a block error rate associated the second power class mode satisfying a threshold.

4. The method of claim 1, further comprising:
receiving a first uplink grant and a second uplink grant of the plurality of uplink grants, each of the first uplink grant and the second uplink grant being associated with a different carrier, wherein the first subset of the uplink messages comprises a first uplink message scheduled by the first uplink grant in accordance with a prioritization scheme indicating to prioritize the first uplink grant indicating a first resource allocation that is larger than a second resource allocation of the second uplink grant.

5. The method of claim 1, further comprising:
receiving a first uplink grant of the plurality of uplink grants that indicates a first resource allocation on a primary component carrier and a second uplink grant of the plurality of uplink grants that indicates a second resource allocation on a secondary component carrier, wherein the first subset of the uplink messages comprises a first uplink message scheduled by the first uplink grant on the primary component carrier in accordance with a prioritization scheme indicating to prioritize transmission via the primary component carrier.

6. The method of claim 1, further comprising:
receiving a first uplink grant of the plurality of uplink grants that indicates a first resource allocation on a first carrier for transmission of control information and first data and a second uplink grant of the plurality of uplink grants that indicates a second resource allocation on a second carrier for transmission of second data, wherein the first subset of the uplink messages comprises the control information and the first data scheduled by the first uplink grant in accordance with a prioritization scheme indicating to prioritize multiplexing data with control information.

7. The method of claim 1, further comprising:
transmitting, using the first power class mode, the first subset of the uplink messages associated with the first subset of the plurality of uplink grants based at least in part on the first subset of the uplink messages being associated with single transmission chain transmission.

8. The method of claim 1, further comprising:
selecting the first subset and the second subset of the plurality of uplink grants based at least in part on a prioritization scheme for prioritization of transmission of uplink messages associated with the plurality of uplink grants.

9. A method for wireless communication at a user equipment (UE), comprising:
transmitting, to a network entity, an advertisement message indicating an uplink transmission duty cycle associated with a first power class mode of the UE, the first power class mode of the UE corresponding to a higher transmission power level than a second power class mode of the UE;
receiving, from the network entity, a plurality of uplink grants associated with a time interval, a quantity of transmission resources scheduled by the plurality of uplink grants during the time interval exceeding the uplink transmission duty cycle associated with the first power class mode;
transmitting, using the first power class mode on a first transmission chain of the UE, a first subset of uplink messages associated with a first subset of the plurality of uplink grants to satisfy the uplink transmission duty cycle for the first transmission chain during the time interval; and
transmitting, using the first power class mode on a second transmission chain of the UE, a second subset of the uplink messages associated with a second subset of the plurality of uplink grants to satisfy the uplink transmission duty cycle for the second transmission chain during the time interval.

10. The method of claim 9, further comprising:
transmitting the first subset of the uplink messages on the first transmission chain and the second subset of the uplink messages on the second transmission chain based at least in part on the plurality of uplink grants being associated with single-input single-output transmission.

11. The method of claim 9, further comprising:
transmitting, during a first portion of the time interval, a first set of sounding reference signals via the second transmission chain and the first subset of the uplink messages via the first transmission chain; and
transmitting, during a second portion of the time interval, a second set of sounding reference signals via the first transmission chain and the second subset of the uplink messages via the second transmission chain.

12. The method of claim 9, further comprising:
transmitting, using the first power class mode on the second transmission chain of the UE, the second subset of the uplink messages during a second portion of the time interval based at least in part on the first subset of uplink grants satisfying the uplink transmission duty cycle during a first portion of the time interval.

13. An apparatus for wireless communications at a user equipment (UE), comprising:
memory;
a transceiver; and
at least one processor of the UE, the at least one processor coupled with the memory and the transceiver and configured to:
transmit, to a network entity via the transceiver, an advertisement message indicating an uplink transmission duty cycle associated with a first power class mode of the UE, the first power class mode of the UE corresponding to a higher transmission power level than a second power class mode of the UE;
receive, from the network entity via the transceiver, a plurality of uplink grants associated with a time interval, a quantity of transmission resources scheduled by the plurality of uplink grants during the time interval exceeding the uplink transmission duty cycle associated with the first power class mode; and
transmit, via the transceiver and using the first power class mode, a first subset of uplink messages associated with a first subset of the plurality of uplink grants to satisfy the uplink transmission duty cycle for the time interval based at least in part on dropping transmission of a second subset of uplink messages associated with a second subset of the plurality of uplink grants.

14. The apparatus of claim 13, the at least one processor further configured to:
transmit, via the transceiver and using the second power class mode, a plurality of uplink signals based at least in part on a second quantity of transmission resources scheduled during a second time interval exceeding the uplink transmission duty cycle associated with the first power class mode.

15. The apparatus of claim 13, wherein the at least one processor configured to transmit the first subset of the uplink messages is further configured to:
transmit, via the transceiver, the first subset of the uplink messages using the first power class mode based at least in part on a block error rate associated the second power class mode satisfying a threshold.

16. The apparatus of claim 13, the at least one processor further configured to:
receive, via the transceiver, a first uplink grant and a second uplink grant of the plurality of uplink grants, each of the first uplink grant and the second uplink grant being associated with a different carrier, wherein the first subset of the uplink messages comprises a first uplink message scheduled by the first uplink grant in accordance with a prioritization scheme indicating to prioritize the first uplink grant indicating a first resource allocation that is larger than a second resource allocation of the second uplink grant.

17. The apparatus of claim 13, the at least one processor further configured to:
receive, via the transceiver, a first uplink grant of the plurality of uplink grants that indicates a first resource allocation on a primary component carrier and a second uplink grant of the plurality of uplink grants that indicates a second resource allocation on a secondary component carrier, wherein the first subset of the uplink messages comprises a first uplink message scheduled by the first uplink grant on the primary component carrier in accordance with a prioritization scheme indicating to prioritize transmission via the primary component carrier.

18. The apparatus of claim 13, the at least one processor further configured to:
receive, via the transceiver, a first uplink grant of the plurality of uplink grants that indicates a first resource allocation on a first carrier for transmission of control information and first data and a second uplink grant of the plurality of uplink grants that indicates a second resource allocation on a second carrier for transmission of second data, wherein the first subset of the uplink messages comprises the control information and the first data scheduled by the first uplink grant in accordance with a prioritization scheme indicating to prioritize multiplexing data with control information.

19. The apparatus of claim 13, the at least one processor further configured to:
transmit, via the transceiver using the first power class mode, the first subset of the uplink messages associated with the first subset of the plurality of uplink grants based at least in part on the first subset of the uplink messages being associated with single transmission chain transmission.

20. The apparatus of claim 13, the at least one processor further configured to:
select the first subset and the second subset of the plurality of uplink grants based at least in part on a prioritization scheme for prioritization of transmission of uplink messages associated with the plurality of uplink grants.
